(19) United States
(12) Patent Application Publication
(10) Pub. No.: US 2024/0097779 A1
(43) Pub. Date: Mar. 21, 2024

(54) TIMING ADVANCE FOR TRANSMITTING INFORMATION IN WIRELESS COMMUNICATION NETWORKS

(71) Applicant: ZTE Corporation, Shenzhen (CN)

(72) Inventors: Fangyu CUI, Shenzhen (CN); Nan ZHANG, Shenzhen (CN)

(21) Appl. No.: 18/487,539

(22) Filed: Oct. 16, 2023

Related U.S. Application Data
(63) Continuation of application No. PCT/CN2021/092700, filed on May 10, 2021.

(51) Int. Cl. H04B 7/185

(52) U.S. Cl. CPC H04B 7/18519

(57) ABSTRACT

A method for wireless communication includes the steps of receiving common timing advance (TA) information indicated by a base station (BS) and determining a common TA value of an uplink (UL) transmission according to the common TA information and time instant information. A method for wireless communication includes the steps of transmitting common timing advance (TA) information indicated by a BS to a user equipment (UE) and scheduling a UL transmission, the common TA information and associated time instant information being adapted to determine a common TA value of the UL transmission of the UE. Other methods for wireless communication and relevant apparatus, computer program products, and non-transitory computer-readable medium are also disclosed.

### RELATED APPLICATION

This application is a continuation of International Application No. PCT/CN2021/092700, filed on May 10, 2021 and entitled “TIMING ADVANCE FOR TRANSMITTING INFORMATION IN WIRELESS COMMUNICATION NETWORKS,” the entirety of which is incorporated by reference.

### TECHNICAL FIELD

This disclosure is generally related to wireless communications, and particularly to timing advance for transmitting information in wireless communications.

### BACKGROUND

Wireless communication technologies are pivotal components of the increasingly interconnecting global communication networks. Wireless communications rely on accurately allocated time and frequency resources for transmitting and receiving wireless signals. In some situations, in order to maintain proper timing of signal transmission and reception between wireless network nodes, transmission time delay may become non-negligible and may need to be taken into consideration when transmitting scheduled wireless signals. For example, timing advance (TA) for wireless signal transmission may be employed to compensate for a transmission time delay. Specifically, the time delay of a signal scheduled to arrive at a receiving network node at a particular time window may be determined as a timing advance. The transmitting network node may transmit the scheduled signal ahead of the scheduled time window by an amount of the timing advance to ensure that the signal can arrive at the receiving network node at the scheduled time window.

### SUMMARY

This summary is a brief description of certain aspects of this disclosure. It is not intended to limit the scope of this disclosure.

An aspect of the embodiment of this disclosure provides a method for wireless communication, including receiving common TA information indicated by a base station (BS) and determining a common TA value of an up-link (UL) transmission according to the common TA information and time instant information.

Another embodiment of this disclosure provides another method for wireless communication. The method includes transmitting common TA information indicated by a BS to a user equipment (UE); and scheduling a UL transmission, the common TA information and associated time instant information being adapted to determine a common TA value of the UL transmission of the UE.

Another embodiment of this disclosure provides another method for wireless communication. The method includes determining a plurality of reference common TA values, including a first reference common TA value and at least one second reference common TA value and transmitting common TA information. The common TA information comprises first information indicating the first reference common TA value and second information indicating at least one offset component of the at least one second reference common TA value with respect to the first reference common TA value.

Another embodiment of this disclosure provides another method for wireless communication. The method includes receiving common TA information, comprising first information indicating a first reference common TA value; and second information indicating at least one offset component of at least one second reference common TA value with respect to the first reference common TA value.

Another embodiment of this disclosure provides another method for wireless communication. The method includes receiving valid time information corresponding to at least one of common TA information or common TA drift information and determining, by using a timer, whether the at least one of the common TA information or the common TA drift information expires according to the valid time information.

Another embodiment of this disclosure discloses another wireless communication apparatus comprising at least one processor and a memory. The at least one processor is configured to read computer code from the memory and implement any one of the methods recited above and disclosed below.

Another embodiment of this disclosure discloses a computer program product comprising a non-transitory computer-readable program medium code stored thereupon, the code, when executed by at least one processor, causing the at least one processor to implement any one of the methods recited above and disclosed below.

Another embodiment of this disclosure discloses a non-transitory computer-readable medium storing at least one program. The program, when executed by at least one processor, causes the at least one processor to implement any one of the methods recited above or disclosed below.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 shows an exemplary network architecture of a non-terrestrial network (NTN) communication system;

FIG. 2 is a flowchart of an exemplary embodiment of the wireless communication method of this disclosure;

FIG. 3 is a flow chart of another exemplary embodiment of the wireless communication method of this disclosure;

FIG. 4 shows a timing diagram of wireless signal transmission according to an exemplary embodiment of this disclosure;

FIG. 5 shows a timing diagram of a plurality of common TA values according to an exemplary embodiment of the disclosure;

FIG. 6 illustrates a wireless signal transmission method according to an exemplary embodiment of this disclosure;

FIG. 7 is a timing diagram of the signal transmission according to another exemplary embodiment of this disclosure;

FIG. 8 illustrates a timing diagram of common TA information and common TA drift information according to an exemplary embodiment of this disclosure;

FIG. 9 shows distribution of common TA values and common TA drift rates according to another exemplary embodiment of this disclosure;

FIG. 10 shows a timing diagram of wireless signal transmission according to an exemplary embodiment of this disclosure;

FIG. 11 shows a system architecture of the user equipment according to an exemplary embodiment of this disclosure;

FIG. 12 shows a flow chart of a method for wireless communication according to an exemplary embodiment of this disclosure; and

FIG. 13 shows a wireless communication apparatus according to an exemplary embodiment of this disclosure.

### DETAILED DESCRIPTION

Various exemplary embodiments of the present disclosure are described below with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

The disclosure below is directed to various timing advance techniques in the context where wireless signal transmission time delays become non-negligible. To maintain timeliness of scheduled wireless reception, a transmission network node may be configured to determine a timing advance (TA) relative to a scheduled reception time window or time instant at the receiving network node, and then use such a timing advance to transmit the wireless signal ahead of the scheduled time window or time instant. As the wireless signal transmission path length between the transmitting network node and the receiving network node may change dynamically, either due to motion of one or both of the transmitting or receiving network nodes, and/or a motion of an intermediate relay network node relative to the transmitting and receiving network nodes, such TA may need to be determined and considered each time a scheduled wireless signal is transmitted by the transmitting network node. Prior to the transmission of a scheduled wireless signal, the TA may be determined by the transmitting network node for that particular time by adjusting one or more base or reference TAs for one or more previous time instants. Such reference TAs may be indicated to the transmission network node via, for example, system signaling channels in various signaling format. Likewise, corresponding previous time instants for the reference TAs may be obtained in advance in various manners, such as via system signaling channels. The adjustment to the reference TAs to obtain a current TA for the transmission of the current wireless signal by the transmitting network node may be further based on TA drift as a result of time lapse since the time instants associated with the reference TAs. Such TA drift may be determined based on information indicated to the transmitting network node in various manners, such as via system signaling channels.

While the exemplary embodiments below are implemented in the context of downlink (DL) and uplink (UL) wireless communication between a fixed base station (BS) and a user equipment (UE) via a moving satellite functioning as intermediate network node, the underlying principles of the following embodiments can apply to other similar wireless communication scenarios, where a high amplitude platform station (HAPS), an airplane, or other moving objects are used as an intermediate communication node.

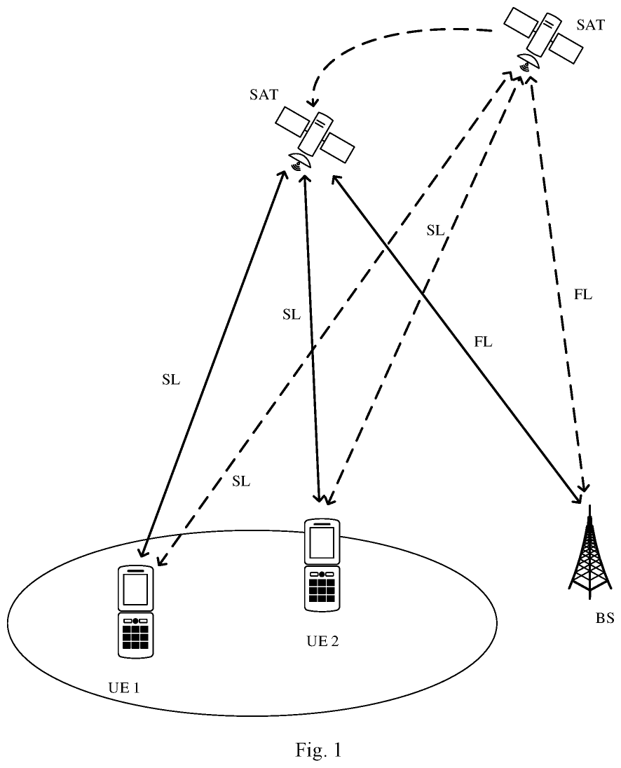

FIG. 1 shows an exemplary network structure of a non-terrestrial network (NTN) communication system. The systems may include one or more sets of UEs, such as UE 1 or UE 2 as shown. The system may further comprise a base station BS and at least one satellite SAT. In a NTN communication system, the data or signal transmission between a UE and a BS may go through an intermediate communication device, such as the satellite SAT. Therefore, a service link SL is established between the satellite SAT and the UE, and another feeder link is established between the BS and the satellite SAT.

For transmission of data or signals, timing advance can be introduced to allow the transmitted signal to arrive at the BS in a proper time window. Timing advance considers the propagation delay of the signal transmission, and a transmitter can transmit the signal or data in advance of a specific time length to compensate the delay. In the NTN context, the position of the BS is generally unknown to the UE. To obtain a more precise timing advance value, the BS may provide common timing advance (TA) information to the UE, such that the UE can consider the propagation delay of the UL transmission to ensure that the transmitted UL signal or data can arrive at the BS at a proper time window (e.g., a scheduled time window or time instant).

Derivation of Common TA Value

However, in the NTN and other similar context, the satellite SAT is moving along with time as shown in FIG. 1. Therefore, there might be some variation of the propagation delay for UL transmission at different times or time instants. Using a fixed common timing advance value only to estimate the required timing advance for UL transmission may be insufficient. Further, due to the relatively large propagation delay and timing drift rate, the DL delay for scheduling an information transmission is not exactly the same as UL delay for the scheduled information transmission in the form of a wireless signal or data from the UE to the BS via the satellite SAT. It may be insufficient to simply derive the timing advance for the UL transmission based on either one of DL feeder link delay and UL feeder link delay.

To mitigate the issue, a reference common TA information provided by the BS may be compensated by a TA drift according to relevant time instant information. For example, a reference common TA value provided by the BS can be compensated according to a scheduling time instant and a TA drift rate (for the drift accumulated before the scheduling time instant of the UL transmission), and further be compensated according to a transmission time instant (with respect to the scheduling time instant) and a TA drift rate (for the drift accumulated between the scheduling time instant and the transmission time instant) to obtain a more accurate common TA value for the UL transmission. It should be noted the embodiments in this disclose may be applicable to different kind of NTN structure, not limited by the structure as shown in FIG. 1.

It should be noted that “common TA drift” refers to the offset between the common TA values at different time instants. “Common TA drift rate” refers to the variation rate of common TA values along with time. “Common TA drift information” refers to the information indicated by a BS, which helps a UE estimate the common TA drift, and as an example, the “common TA drift information” may contain a first-order common TA drift rate (or called “common TA drift rate”), a second-order common TA drift rate (or called “common TA drift rate variation”), and even higher order drift rates.

The term “common” is used herein to indicate that the corresponding TA is common to the various UEs communicating with the BS, as such a TA is mainly determined by the feeder link delay between the BS and the satellite, independent of the UEs. With respect to a particular UE, the word “common” can be omitted without affecting understanding of the current disclosure.

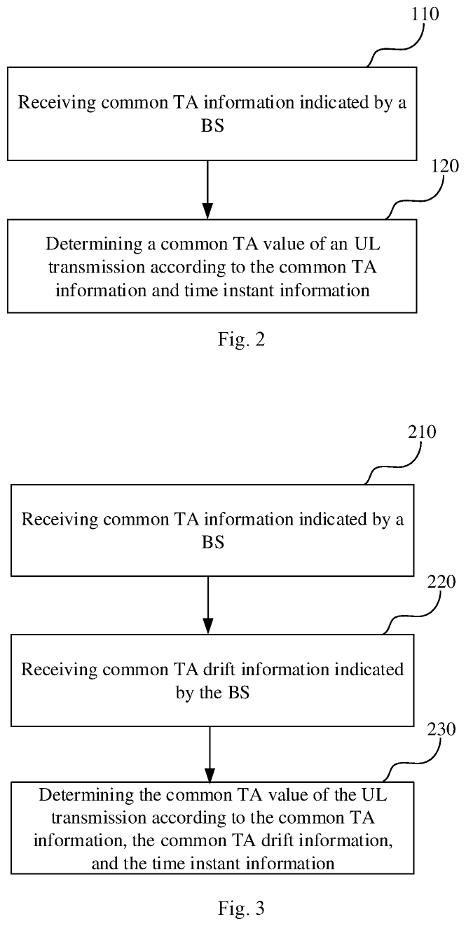

FIG. 2 is a flow chart of one exemplary embodiment of the wireless communication method of this disclosure. The wireless communication method includes:

Step 110: Receiving common TA information indicated by a BS; and

Step 120: Determining a common TA value of a UL transmission according to the common TA information and time instant information.

FIG. 3 is another flow chart of another exemplary embodiment of the wireless communication method of this disclosure. The wireless communication method includes:

Step 210: Receiving common TA information indicated by a BS;

Step 220: Receiving common TA drift information indicated by the BS; and

Step 230: Determining the common TA value of the UL transmission according to the common TA information, the common TA drift information, and the time instant information.

In the embodiment of FIG. 3, while the common TA information and the common TA drift information are received respectively at the two different steps, the common TA information and the common TA drift information can be indicated in the same system information block (SIB), and may be embedded together. The detailed implementation of the above Steps are illustrated below along with exemplary figures.

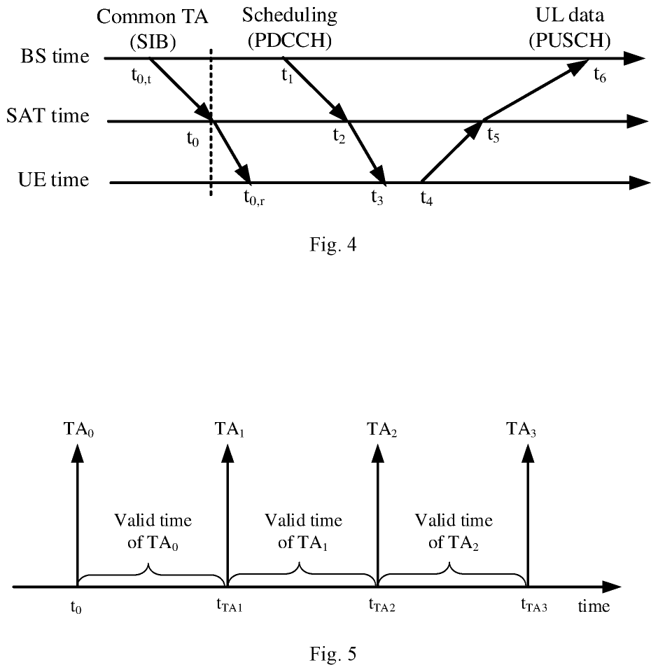

FIG. 4 shows a timing diagram of signal transmission according to an embodiment of this disclosure. The time diagram of FIG. 4 is illustrative of the operation of the NTN network system of FIG. 1. As shown in FIG. 4, the BS broadcasts/transmits common TA information at time t0,t carried by, for example, a System Information Block (SIB). The common TA information is associated with activation time t0, which may be identical to the time when the common TA information with the SIB passes by the satellite SAT, but not necessarily. Further, the BS may transmit a scheduling signal through physical downlink control channel (PDCCH) at time t1 for the UE to transmit UL data. As shown in FIG. 4, the scheduling signal passes by the satellite SAT at time t2 and is received by the UE at time t3. The scheduling signal is used to provide scheduling time and other allocations to the UE on a physical Uplink Shared Channel (PUSCH). Thereafter, the UE transmits UL data at time t4 via PUSCH according to the scheduling, and the UL data passes by the satellite SAT at time t5, and then the UL data is received by the BS at time t6.

As explain above, due to relatively the large propagation delay and timing drift associated with feeder link between the BS and the satellite, the actual common TA for the UL transmission at t4 is no longer equal to the reference value indicated at activation time t0 by the BS in order to compensate the propagation delay properly. Moreover, the DL feeder link delay for the transmission of the scheduling signal between the times t2 and t1 may be not be exactly same as UL feeder link delay for UL data to travel from the satellite SAT to the BS between times t5 and t6. In order to mitigate the common TA misalignment, the TA drift during the times between the activation time instants of the common TA information and UL transmission may be determined, and a proper common TA value may be derived for the transmission of the UL data.

Specifically, the DL delay is determined by the satellite SAT position at time t2 since the satellite SAT is the receiver, while the UL delay is determined by the satellite SAT position at time t5 since the satellite is the transmitter. The difference between DL feeder link delay and UL feeder link delay is the accumulated one-way feeder link delay drift during the time between t2 and t5. The common TA drift can be expressed as Δt_{feeder,t}_{₂}_{→t}_{₅}. The common TA value applied in the PUSCH transmission of the UL data can be derived according to,

TA=TAₜ_{₂}+Δt_{feeder,t}_{₂}_{→t}_{₅} (1)

wherein TAₜ_{₂} is the common TA value at the time instant when scheduling signal is transmitted, and TA is the common TA value applied in the PUSCH transmission.

Further, the common TA value TAₜ_{₂} at the time instant when scheduling signal is transmitted can be further expressed by the following equation,

TAₜ_{₂}=TAₜ_{₀}+ΔTAₜ_{₀}_{→t}_{₂} (2)

wherein TAₜ_{₀} is a reference common TA value indicated by the BS with an activated time t₀, and ΔTAₜ_{₀}_{→t}_{₂} is the TA drift between the times t₀ and t₂. Based on equation (1) and (2), The TA applied in PUSCH transmission of the UL data can be derived from the reference common TA value TAₜ_{₀} indicated by the BS with the activated time to, adjusted by the TA drift ΔTAₜ_{₀}_{→t}_{₂} between times t₀ and t₂, and the accumulated one-way delay drift Δt_{feeder,t}_{₂}_{→t}_{₅} during the times t₂ and t₅. That is,

TA=TAₜ_{₀}+ΔTAₜ_{₀}_{→t}_{₂}+Δt_{feeder,t}_{₂}_{→t}_{₅} (3)

Further, the BS may provide a TA drift information, including information such as a TA drift rate TA_{drift}, for estimating the TA drift between time t₀ and t₂ and the TA drift between times t₂ and t₅. The accumulated round-trip TA drift between the times t₀ and t₂ can be derived by

ΔTAₜ_{₀}_{→t}_{₂}=(t₂−t₀)·TA_{drift} (4),

wherein TA drift is TA draft rate indicated by the BS.

Similarly, the accumulated one-way delay drift during the times t₂ and t₅ Δt_{feeder,t}_{₂}_{→t}_{₅} can be estimated by the following equation,

$$Δ {t}_{feeder , {t}_{2} \to {t}_{5}} = ( {t}_{5} - {t}_{2} ) \cdot \frac{{TA}_{drift}}{2} . \qquad ( 5 )$$

Therefore, if a first order TA drift rate is indicated by the BS in a common TA drift information, the TA value for the round-trip UL transmission of the UL data can estimated by the following equation,

$$TA = {TA}_{{t}_{0}} + ( {t}_{2} - {t}_{0} ) \cdot {TA}_{drift} + ( {t}_{5} - {t}_{2} ) \cdot \frac{{TA}_{drift}}{2} . \qquad ( 6 )$$

Therefore, the common TA value for the UL transmission of the UL data TA can be derived according to the reference common TA value TAₜ_{₀}, the TA drift rate TA_{drift}, and the relevant time instant information, such as the activation time instant t₀, scheduling time instant t₂, and transmission time instant t₅. In the other words, the common TA value of the UL transmission may be determined according to a reference common TA value and a time offset between the UL transmission time instant and an activation time instant associated with the reference common TA value.

In one implementation, the transmission time instant t5 may depend on the common TA value for the UL transmission, which, from Equation (6), depends on t5. As such, in order to determine both t5 and TA, Equation (6) may be used recursively. For example, t5 may be set to t2 first to obtain a first iteration TA. Such a TA may then be used to determine a transmission time and t5. The new t5 may then be used according to Equation (6) in a second iteration to determine a new TA. These t5 recursive iterations may be performed for a predetermined number of times or until the TA and the t5 converges.

Alternatively, the UE may derive the time t5 according to the scheduling of PUSCH indicated by the BS, the reference common TA value at time t₀, and the common TA drift rate. Specifically, the BS may indicate the time t₆ as when the UL data is expected to arrive at the BS. The (approximate) propagation time between t₅ and t₆ can be derived by the common TA value at time t₀ (i.e., TAₜ_{₀}) and corresponding common TA drift rate (i.e., TA_{drift}). By solving the following equation, time is can be derived alternatively:

$${t}_{6} - {t}_{5} = \frac{{TA}_{{t}_{0}} + ( {t}_{5} - {t}_{0} ) \cdot {TA}_{drift}}{2} \qquad ( 6 - 1 )$$

In addition, the TA discussed above only take into consideration of the feeder link delay. Between the BS and the satellite. To determine the actual UL transmission time instant, the service link propagation delays between the satellite and the UE may also be considered. Such delays can be estimated by the UE using, for example, known satellite position and UE location.

Further, to estimate the common TA value for the UL transmission more precisely, the BS can include additional factors, such as a second order common TA drift rate (or common TA drift rate variation), in the common TA information provided to the UE.

Accordingly, the common TA drift ΔTAₜ_{₀}_{→t}_{₂} between the times t₀ and t₂ can be derived by the following equation,

ΔTAₜ_{₀}_{→t}_{₂}=(t₂−t₀)·TA_{drift}+½(t₂−t₀)²·TA_{drift,dirft} (7),

wherein TA_{drift,dirft} is the second order common TA drift rate.

Further, the accumulated one-way feeder link delay drift Δt_{feeder,t}_{₂}_{→t}_{₅} during the times t₂ and t₅ can be derived by the follow equation,

$$Δ {t}_{feeder , {t}_{2} \to {t}_{5}} = ( {t}_{5} - {t}_{2} ) \cdot \frac{{TA}_{drift}}{2} + \frac{1}{2} {( {t}_{5} - {t}_{2} )}^{2} \cdot \frac{{TA}_{drift , dirft}}{4} . \qquad ( 8 )$$

Accordingly, the common TA value for the UL transmission can be derived by the following equation when a first order common TA drift rate and a second order common TA drift rate are provided,

$$TA = {TA}_{{t}_{0}} + ( {t}_{2} - {t}_{0} ) \cdot {TA}_{drift} + \frac{1}{2} {( {t}_{2} - {t}_{0} )}^{2} \cdot {TA}_{drift , drift} + ( {t}_{5} - {t}_{2} ) \cdot \frac{{TA}_{drift}}{2} + \frac{1}{2} {( {t}_{5} - {t}_{2} )}^{2} \cdot \frac{{TA}_{drift , drift}}{4} . \qquad ( 9 )$$

That is, the TA value for the UL transmission of the UL data can be derived according to the reference common TA value, the first order common TA drift rate, the second order common TA drift rate, and relevant time instant information, such as the times activation time instant t0, scheduling time instant t2, and transmission time instant t5.

FIG. 5 shows a timing diagram of plural common TA values according to another embodiment of the disclosure. In one embodiment, the BS can provide the UE common TA information including a plurality of reference common TA values corresponding to different valid times. The plurality of the reference common TA values are used in their corresponding valid times as the common TA values for UL transmission. Alterative, the plurality of the reference common TA values are used in a corresponding valid time to serve as a parameter to derive an estimated common TA values for UL transmission. As shown in FIG. 5, TA0, TA1, and TA2 correspond to the time frames between t0, tTA1, tTA2, and tTA3. The times t0, tTA1, and tTA2 indicate the activation times of the reference common TA values TA0, TA1, and TA2. The plurality of the reference common TA values may be bundled and indicated together in the same SIB, but not necessarily. The valid times for the plurality of reference common TA values may be indicated in the same SIB with the plurality of the common TA values, but is not required. The valid times for the plurality of reference common TA values may be bundled and indicated together in the same SIB. Further, the reference common TA values and the valid times can be indicated in various formats that are indicative of the timing advance and the valid periods.

Even if the BS indicates a plurality of the reference common TA values corresponding to different valid times, UL transmission in a specific valid time frame is not limited to consider only one reference common TA value of the specific valid time frame as its common TA value for the UL transmission. For example as shown in FIG. 5, UL transmission in the valid time of a reference common TA values TA1 can take the corresponding reference common TA values TA1 as its TA value for the UL transmission. Alternatively, the UE can derive a common TA value for the UL transmission by further considering the common TA value(s) of adjacent valid time frame(s). Specifically, an interpolation technique may be introduced for a more accurate estimation of the common TA value for UL transmission. For example, for a UL transmission scheduled at time t between time tTA1 and tTA2 in FIG. 5, the TA value for UL transmission at time t can be derived by the following equation,

$${TA}_{t} = {TA}_{1} + \frac{t - {t}_{TA 1}}{{t}_{TA 2} - {t}_{TA 1}} \cdot ( {TA}_{2} - {TA}_{1} ) , \qquad ( 10 )$$

wherein
TAₜ is the TA value for the UL transmission at time t,
TA₁ is the reference common TA value of valid time of the UL transmission,
TA₂ is the subsequent reference common TA value of the subsequent valid time,
t is the time the UL transmission is scheduled,
t_{TA1} is the activation time of the reference common TA value TA₁, and
t_{TA2} is the activation time of the reference common TA value TA₂.

Therefore, the common TA value for the UL transmission at time t may be determined according to the two sequential reference common TA values and the relative time gap between the time t and the activation times of the two sequential reference common TA value. The closer the time t is to the activation time of a certain reference common TA value, the weight of the certain reference common TA is higher.

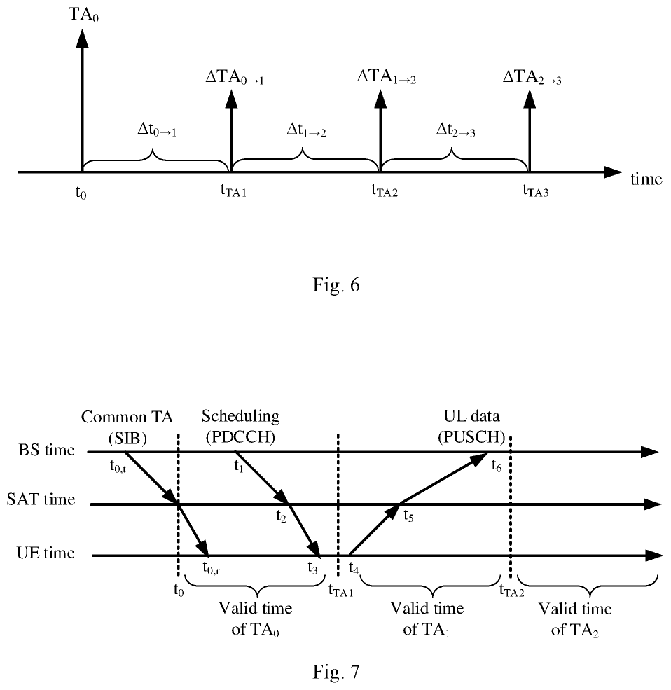

FIG. 6 illustrates a transmission method according to an embodiment of this disclosure. In this implementation, the overhead of providing the common TA information indicative of the plurality of the reference common TA values can be reduced by reporting one first reference common TA value and reporting a series of offsets, each corresponding the rest of the second reference common TA values. The offsets indicate discrepancy of the at least one reference second common TA values with respect to the first reference common TA value. For example, as shown in FIG. 6, the BS may indicate the TA₀ as a base reference common TA value, and the BS indicates the offsets ΔTA_{0→1}, ΔTA_{1→2}, and ΔTA_{2→3} corresponding to three subsequent reference common TA values (i.e., the at least one second common TA value).

Further in one implementation, the offset may indicate discrepancy of two sequential reference common TA values. For example, the indicated offset for the reference common TA value TA2 activated at time tTA2 may include the discrepancy of the reference common TA value TA2 with respect to the preceding reference common TA value TA1. Because the value of the reference common TA value TA1 is indicated by the BS in also a offset format, the UE can derive the actual reference common TA value of TA2 according to the offset of the preceding reference common TA value TA1 and the offset of the instant reference common TA value TA2 by adding the two offsets of the reference common TA values TA1 and TA2 to the base reference common TA value TA0, which the BS indicates with information of a full TA value.

In another implementation, the BS may indicate each offset of the each following reference common TA value with the discrepancy of each of the following reference common TA value with respect to the closest preceding reference common TA value with an indicated full value. For example, the offsets of the reference common TA values TA1 and TA2 are their respectively offsets with respect to the base reference common TA value TA0. In this case, the UE derives the original reference common TA value by adding the corresponding offset of each following reference common TA value to the base reference common TA value TA0.

The above information indication method can also be applied to effectuate indication of common TA drift rates and valid times. For example, the BS may indicate a first valid time, followed by a series of offsets corresponding to a series of valid times following the first valid time. Each offset may indicate the discrepancy between a corresponding valid time and the first valid time, or it may alternatively indicate the discrepancy between the corresponding valid time and a valid time directly preceding the corresponding valid time.

Likewise, the BS may also indicate a first common TA drift rate, followed by a series of offsets corresponding to a series of common TA drift rates following the first common TA drift rate. Each offset may indicate the discrepancy between a corresponding common TA drift rate and the first common TA drift rate, or it may alternatively indicate the discrepancy between the corresponding common TA drift rate and a common TA drift rate directly preceding the corresponding common TA drift rate. The UE can use the base value and the offset to derive the original value of either a valid time or a common TA drift rate.

FIG. 7 is a timing diagram of the signal transmission according to one exemplary embodiment of this disclosure. In FIG. 7, while the plurality of reference common TA values have their corresponding valid time frames, UL transmission in a specific time frame may have a common TA value for the UL transmission derived from the reference common TA values of the specific time frame and neighbor time frame(s). For example, as shown in FIG. 7, for the UL transmission at time t4, the common TA value for the UL transmission can be an average of the reference common TA values TA0 and TA1. TA0 may be the reference common TA value between the times t0 and tTA1, and TA1 may be the reference common TA value between the times tTA1 and tTA2. By considering the reference common TA value of the time frame of the instant UL transmission and the reference common TA value of the time frame of the scheduling signal, a proper common TA value for the UL transmission can be derived more accurately to mitigate the discrepancy caused by inequality of DL and UL delays.

Further in one implementation, an interpolation approach may be introduced to estimate a more accurate common TA value for the UL transmission when a scheduling time instant is located in a different valid time from the transmission time instant. In this implementation, the common TA value for the UL transmission at time t4 (as shown in FIG. 7) can be an average of the adjusted reference common TA values TAt2 and TAt5 for time t2 and t5. Time t2 may be the time when the scheduling signal passes by the satellite SAT, and time t5 may be the estimated time when the UL data arrive at the satellite SAT. The common TA value for the UL transmission at time t₄ can be derived by the following equations,

$${TA}_{t 4} = \frac{{TA}_{t 2} + {TA}_{t 5}}{2} , where \qquad ( 11 )$$

$${TA}_{t 2} = {TA}_{0} + \frac{{t}_{2} - {t}_{0}}{{t}_{TA 1} - {t}_{0}} \cdot ( {TA}_{1} - {TA}_{0} ) , and \qquad ( 12 )$$

$${TA}_{t 5} = {TA}_{1} + \frac{{t}_{5} - {t}_{TA 1}}{{t}_{TA 2} - {t}_{TA 1}} \cdot ( {TA}_{2} - {TA}_{1} ) , \qquad ( 13 )$$

wherein
TAₜ₄ is the common TA value of the UL transmission at t₄,
TAₜ₂ is the adjusted common TA value of t₂,
TAₜ₅ is the adjusted common TA value of t₅,
TA₁ is the reference common TA value activated at t_{TA1},
TA₂ is the reference common TA value activated at t_{TA2},
TA₀ is the reference common TA value activated at t₀,
t₀ is the activation time of TA₀,
t₂ is the scheduling time instant,
t₅ is the transmission time instant,
t_{TA1} is the activation time of TA₁, and
t_{TA2} is the activation time of TA₂.

In the above equations, common TA value TAₜ₂ and TAₜ₅ for times t₂ and t₅ are estimated using the interpolation technique, and then a common TA value for the UL transmission is estimated by the average of TAₜ₂ and TAₜ₅. In summary, the common TA value of the UL transmission may be determined according to a common TA values of a latest UL transmission and a time offset between the UL transmission and the latest UL transmission.

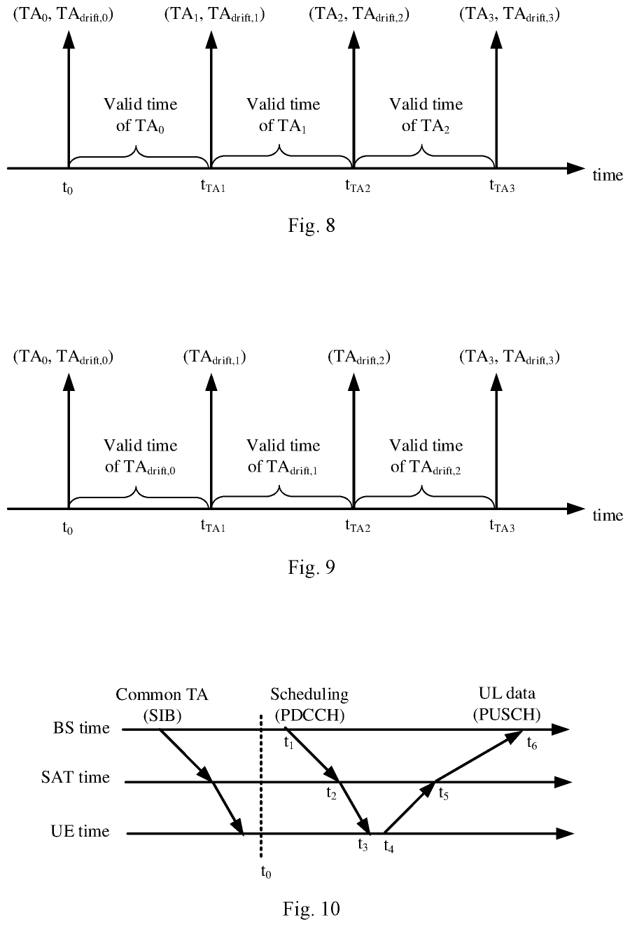

FIG. 8 illustrates a timing diagram of common TA information and common TA drift information according to one embodiment of this disclosure. Similar to FIG. 5, where the common TA information comprises a plurality of reference common TA values corresponding to different valid times, here the common TA information provided by the BS comprises a plurality of reference common TA values along with a plurality of common TA drift rates corresponding to different valid times. For example, the times t0, tTA1, tTA2, and tTA3 indicate the activation times of the reference common TA values TA0, TA1, TA2, and TA3 as shown in FIG. 8. The times t0, tTA1, tTA2, and tTA3 also indicate the activation times of the common TA drift rate TAdrift,0, TAdrift,1, TA drift,2, and TA drift,3 as shown in FIG. 8. Therefore, the UE can derive the common TA value for the UL transmission at different valid times according to the common TA information and the common TA drift information. For example, if a UL transmission is scheduled at valid time of TA1, the common TA value for UL transmission can be derived according to the reference common TA values TA1 and common TA drift rate TAdrift,1 by using, for example, the equations (3) or (9) above.

FIG. 9 shows distribution of common TA values and common TA drift rates according to another exemplary embodiment of this disclosure. As shown in FIG. 8, multiple common TA drift rates' valid times may share a same reference common TA value. That is, the BS may skip the indication of the reference common TA values of certain valid time of common TA drift rate. For example, as shown in FIG. 8, the BS only indicates the common TA drift rates for the time between tTA1 and tTA2 and the time between tTA2 and tTA3, but the time between tTA1 and tTA2 and the time between tTA2 and tTA3 does not have an updated reference common TA. In this arrangement, the valid time without a specifically assigned reference common TA value will use the reference common TA values assigned to neighbor valid times. For example, when one reference common TA value, TAₜ_{₀} is followed by N first order common TA drift rates, if t2 (the scheduling time instant as shown in FIG. 4) is in the valid time of TAdrift,i, t5 (the transmission time instant as shown in FIG. 4) is in the valid time of TAdrift,j, and j>i≥1, the following equation can be used to derived the common TA value,

$$Δ {TA}_{{t}_{0} \to {t}_{2}} = ( {t}_{TA 1} - {t}_{0} ) \cdot {TA}_{drift , 0} + {\sum }_{n = 1}^{i} ( {t}_{TA , n} - {t}_{TA , n - 1} ) \cdot {TA}_{drift , n - 1} + ( {t}_{2} - {t}_{TA , i} ) \cdot {TA}_{drift , i} \qquad ( 14 )$$

$$Δ {t}_{feeder , {t}_{2} \to {t}_{5}} = ( {t}_{TA , i + 1} - {t}_{2} ) \cdot \frac{{TA}_{drift , i}}{2} + {\sum }_{n = i + 2}^{j} ( {t}_{TA , n} - {t}_{TA , n - 1} ) \cdot \frac{{TA}_{drift , n - 1}}{2} + ( {t}_{5} - {t}_{TA , j} ) \cdot \frac{{TA}_{drift , j}}{2} \qquad ( 15 )$$

$$TA = {TA}_{{t}_{0}} + Δ {TA}_{{t}_{0} \to {t}_{2}} + Δ {t}_{feeder , {t}_{2} \to {t}_{5}} = {TA}_{{t}_{0}} + ( {t}_{TA 1} - {t}_{0} ) \cdot {TA}_{drift , 0} + {\sum }_{n = 1}^{i} ( {t}_{TA , n} - {t}_{TA , n - 1} ) \cdot {TA}_{drift , n - 1} + ( {t}_{2} - {t}_{TA , i} ) \cdot {TA}_{drift , i} + ( {t}_{TA , i + 1} - {t}_{2} ) \cdot \frac{{TA}_{drift , i}}{2} + {\sum }_{n = i + 2}^{j} ( {t}_{TA , n} - {t}_{TA , n - 1} ) \cdot \frac{{TA}_{drift , n - 1}}{2} + ( {t}_{5} - {t}_{TA , j} ) \cdot \frac{{TA}_{drift , j}}{2} \qquad ( 16 )$$

If i=0, only one common TA drift rate is used for t₀ to t₂, that is,

ΔTAₜ_{₀}_{→t}_{₂}=(t₂−t₀)·TA_{drift,0} (17).

If j=1, only one common TA drift rate is used for time t₂ to t₅, that is,

$$Δ {t}_{feeder , {t}_{2} \to {t}_{5}} = ( {t}_{5} - {t}_{2} ) \cdot \frac{{TA}_{drift , i}}{2} , \qquad ( 18 )$$

then the common TA value for the UL transmission can be derived according to equation (3).

In the above equation (14), the common TA drift between t₀ and t₂ is derived first, and in the above equation (15), the common TA drift between t₅ and t₂ is thereby derived. Then, the common TA value for UL transmission is the common TA value TAₜ_{₀} plus common TA drift between t₀ and t₂ and common TA drift between t₀ and t₂. When second order drift rates are also used in the arrangement as shown in FIG. 7, the common TA value for the UL transmission can be derived by applying the principle of equation (9).

Indication of Time Instants

Some above embodiments disclose deriving the common TA value for the UL transmission according to the reference common TA value, the common TA drift rate, and relevant time instant information, such as the activation time instant t0, scheduling time instant t2, and transmission time instant t5. The UE can obtain the information of the time instants by different means as described below.

For example, the UE can obtain the time instant information by an implicit indication. In this case, the time instant information is implicitly indicated based on the start or ending boundary of a slot, a sub-frame, or a frame of a system information block (SIB). The UE could derive the time indicated from BS after DL synchronization.

For example, the common TA information can be broadcasted to UE(s) through a SIB. The activation time t0 of the common TA information/value can be set as the end boundary of the last slot (or time slot), sub-frame, or frame carried the SIB. In this case, the UE is able to determine when the indicated reference common TA values are activated and performs the above derivation to obtain the common TA value for UL transmission.

The same boundary of a slot, sub-frame, or frame may correspond to different absolute time at the BS, the satellite SAT and different UEs due to the propagation delay. In order to avoid misalignment, the BS and the UE may have consensus on where the reference point of the time is. Since the BS's position is usually unknown by the UE, the time at the BS be difficulty for the UE to derive. Moreover, different UEs may have different positions; therefore, it is may not be practical to locate reference point for time at a specific UE. Therefore, the satellite SAT can be used as the reference point for time, that is, the absolute time when the boundary of a slot, sub-frame, or frame passes by satellite SAT is regarded as the actual time.

In addition, the absolute time when the boundary of a slot, sub-frame, or frame passes by the satellite SAT can be derived by both the BS and UEs. For example, as shown in FIG. 4, the activation time t0 can be set as the end boundary of SIB containing the common TA information at the satellite SAT, which can be derived by the BS and the UE by adding feeder link delay on transmission time t0,t and reducing service link delay on reception time t0,r. Similarly, the UE can also derive t2 and t5 according to the delay of the propagation time. The above time instants can be used by the UE to derive the drift values ΔTAₜ_{₀}_{→t}_{₂} and Δt_{feeder,t}_{₂}_{→t}_{₅}. With the activation time instant t0, the BS can correctly indicate the reference common TA value TAₜ_{₀} of a specific activation time.

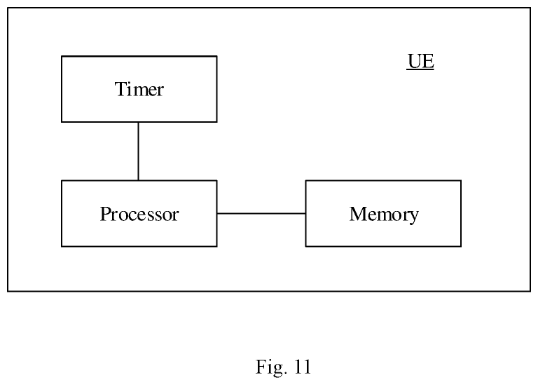

Alternatively, the time instants can be indicated explicitly. In this case, the BS may explicitly transmit a timestamp to UE to indicate time instant information. The timestamp may be included in the common TA information or other information packages, and it can also be separately transmitted. The timestamp can be included in the same STB of the common TA information, but not required. For example, the BS may directly indicate the absolute time of t0 to the UE to allow the UE to derive when common TA information or a reference common TA value is activated. Then, the UE could use the activation time instant indicated here along with other information to derive the common TA value for the UL transmission as illustrated by this disclosure. In this case, the activation time instant t0 is not necessarily associated or the same with the time when SIB containing the common TA information is transmitted (as indicated, exemplarily, by the time when the boundary of a slot, sub-frame, or frame passes by the satellite SAT) as in implicit indication method. The common TA can be activated in any time, e.g., a period substantially after the indication of the common TA information as shown in FIG. 10. In FIG. 10 the activation time instant t0 is indicated to be a time after the SIB carrying the common TA information arrived the UE.

Further, in order to achieve explicit indication of time information, the BS and the UE may be synchronized to the same reference time, e.g., Global navigation satellite system (GNSS) time. There may be error of TA derivation caused by different references of absolute time. Hence, the oscillator error of UE should be small enough, which brings higher synchronization requirement.

Valid Time Monitoring

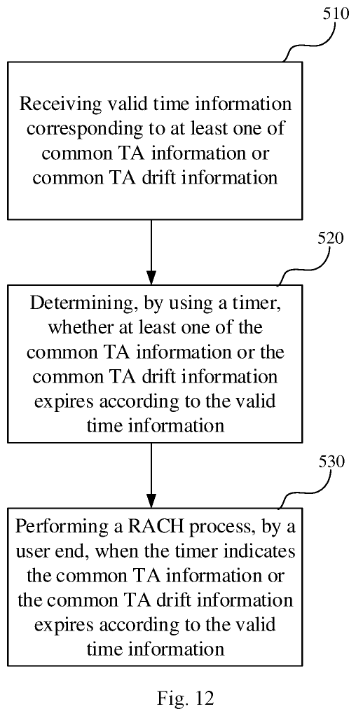

According to an exemplary embodiment of this disclosure, each indicated reference common TA value and/or TA drift rate may be associated with a period of valid times. In the valid times, the corresponding reference common TA value and the common TA drift rate are considered accurate enough. Accordingly, the UE may have a timer as shown in FIG. 11. The timer may be electrically coupled to one or more processors, and the one or more processors are further coupled to the one or more sets of memory, which stores at least one program to be executed by the one or more processors. The UE may perform the following steps as shown in FIG. 12, including:

Step 510: Receiving valid time information corresponding to at least one of common TA information or common TA drift information; and

Step 520: Determining, by using a timer, whether the at least one of the common TA information or the common TA drift information expires according to the valid time information.

If the timer indicates that the common TA information/value or the common TA drift information expires according to the valid time information, the UE further,

Step 530: performing a RACH process, by a user equipment, to re-access the network.

Further, the timer of the UE may be reset under at least one of the following conditions: subsequent common TA information is activated, a subsequent common TA drift information is activated, a MAC CE TA command is received, or a command to reset the timer is received. Specifically, the BS may estimate the TA misalignment based on the UL transmission result. The BS may request an adjustment of the TA by a MAC CE TA command. Once a MAC CE TA command is received by the UE along with the adjustment of the TA, the timer may be reset.

Wireless Communication Apparatus

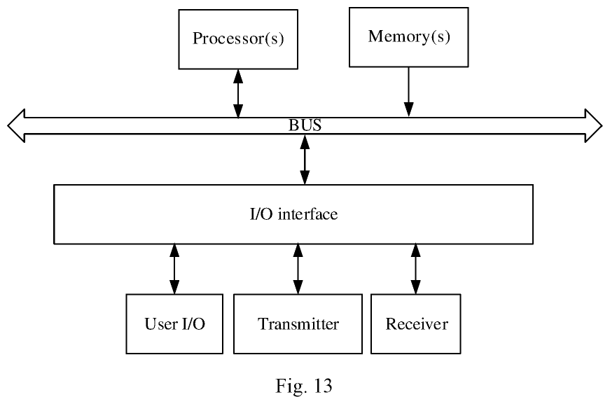

FIG. 13 shows a wireless communication apparatus according to an embodiment of this disclosure. This structure may be used as a UE or a BS. The wireless communication apparatus comprises one or more processors and one or more sets of memory. The memory stores one or more non-transitory computer readable medium programs. The one or more processors can execute the non-transitory computer-readable medium program to perform the method for wireless communication illustrated above. Exemplarily, the wireless communication apparatus may comprise transmitter and receiver to transmit or to receive signals. The wireless communication apparatus may also include user input/output interface to accept user commands.

Further, the at least one program stored in the memory can be transported by a computer program product. The computer program product comprises a non-transitory computer-readable program medium code stored thereupon. The code, when executed by at least one processor, causes at least one processor to implement the method for wireless communication program illustrated above.

TABLE 1
below list the acronyms used in this disclosure.

| Acronym | Full Name |
|---|---|
| NTN | Non-terrestrial network |
| TA | Timing advance |
| BS | Base station |
| GW | Gateway |
| UE | User equipment |
| GNSS | Global navigation satellite system |
| DL | Downlink |
| UL | Uplink |
| SIB | System information block |
| PUSCH | Physical uplink shared channel |
| PDCCH | Physical downlink control channel |
| RACH | Random access channel |

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

1. A method for wireless communication, comprising:
receiving common timing advance (TA) information indicated by a base station (BS); and
determining a common TA value of an uplink (UL) transmission according to the common TA information and time instant information.

2. The method of claim 1, wherein determining the common TA value of the UL transmission according to the common TA information and the time instant information comprises determining the common TA value of the UL transmission according to a reference common TA value and a time offset between a UL transmission time instant and an activation time instant associated with the reference common TA value.

3. (canceled)

4. The method of claim 1, further comprising receiving common TA drift information indicated by the BS, wherein determining the common TA value of the UL transmission according to the common TA information and the time instant information comprises determining the common TA value of the UL transmission according to the common TA information, the common TA drift information, and the time instant information.

5. The method of claim 4, wherein determining the common TA value of the UL transmission according to the common TA information, the common TA drift information, and the time instant information comprises:
determining a common TA drift accumulated before scheduling of the UL transmission by the BS.

6. The method of claim 4, wherein the time instant information comprises at least one of:
a transmission time instant of the UL transmission;
an activation time instant associated with at least one parameter included in the common TA information; or
a scheduling time instant of the UL transmission.

7. The method of claim 6, wherein determining the common TA value of the UL transmission according to the common TA information, the common TA drift information, and the time instant information comprises at least one of:
determining a common TA drift between the scheduling time instant and the transmission time instant of the UL transmission, or
determining the common TA value of the UL transmission according to a reference common TA value included in the common TA information, a common TA drift accumulated before scheduling of UL transmission, and a common TA drift between the scheduling time instant and the transmission time instant of the UL transmission.

8.-9. (canceled)

10. The method of claim 7, further comprising at least one of:
determining the common TA drift between the scheduling time instant and the transmission time instant of the UL transmission according to a common TA drift rate included in the common TA drift information and the scheduling time instant and transmission time instant of the UL transmission; or
determining the common TA drift between the scheduling time instant and the transmission time instant of the UL transmission according to a common TA drift rate and a common TA drift rate variation included in the common TA drift information, and the scheduling time instant and transmission time instant of the UL transmission.

11.-17. (canceled)

18. The method of claim 4, wherein the time instant information comprises at least one time instant associated with an intermediate communication device and determining the common TA value of the UL transmission according to the common TA drift rate and the at least one time instant comprises determining the at least one time instant according to pass-by time at the intermediate communication device of a boundary of at least one of a last slot, sub-frame, or frame of a system information block (SIB) for the BS.

19.-21. (canceled)

22. The method of claim 1, wherein the common TA information comprises a plurality of reference common TA values in one system information block (SIB).

23. The method of claim 22, wherein the common TA information further comprises at least one corresponding valid time in the SIB corresponding to the plurality of reference common TA values.

24. (canceled)

25. The method of claim 22, wherein determining the common TA value of the UL transmission according to the common TA information and the time instant information comprises:
determining a first adjusted common TA value according to a first interpolation value derived according to a scheduling time instant and first and second reference common TA values of the plurality reference common TA values;
determining a second adjusted common TA value according to a second interpolation value derived according to a transmission time instant, the second reference common TA value, and a third reference common TA value of the plurality reference common TA values; and
determining the common TA value of the UL transmission according to the first and second adjusted common TA values.

26. The method of claim 22, wherein determining the common TA value of the UL transmission according to the common TA information and the time instant information comprises determining the common TA value of the UL transmission according to a interpolation value derived from first and second reference common TA values of the plurality of reference common TA values scheduled to be activated sequentially.

27. (canceled)

28. The method of claim 1, wherein the common TA information comprises:
a first reference common TA value and at least one offset component corresponding to at least one second reference common TA value with respect to the first reference common TA value; or
a first valid time corresponding to a first reference common TA value and at least one offset component, with respect to the first valid time, of a second valid time corresponding to at least one second reference common TA value or corresponding to at least one offset component of the at least one second reference common TA value with respect to first reference common TA value.

29.-31. (canceled)

32. The method of claim 1, further comprising receiving at least one timestamp indicating the time instant information, wherein determining the common TA value of the UL transmission according to the common TA information and the time instant information comprises determining the common TA value of the UL transmission according to the common TA information and the at least one timestamp, the at least one timestamp being indicative of at least one of:
an activation time instant of at least one parameter of the common TA information, or
an activation time instant of at least one parameter of common TA drift information.

33.-35. (canceled)

36. A method for wireless communication, comprising:
transmitting common timing advance (TA) information indicated by a base station (BS) to a user equipment (UE); and
scheduling an uplink (UL) transmission, the common TA information and time instant information being adapted to determine a common TA value of the UL transmission of the UE.

37.-58. (canceled)

59. A method for wireless communication, comprising:
receiving valid time information corresponding to at least one of common timing advance (TA) information or common TA drift information; and
determining, by using a timer, whether the at least one of the common TA information or the common TA drift information expires according to the valid time information.

60. The method of claim 59, further comprising resetting the timer when at least one of the following conditions is met: subsequent common TA information is activated, a subsequent common TA drift information is activated, a user equipment receives a MAC CE TA command, or a command to reset the timer is received.

61. (canceled)

62. A wireless communication apparatus comprising at least one processor and at least one memory, wherein the at least one processor is configured to read code from the at least one memory to implement the method recited in claim 1.

63. (canceled)

64. A non-transitory computer-readable medium storing at least one program, the program, when executed by at least one processor, causing the at least one processor to implement the method recited in claim 1.

65. A wireless communication apparatus comprising at least one processor and at least one memory, wherein the at least one processor is configured to read code from the at least one memory to implement the method recited in claim 36.
